(19) United States
(12) Patent Application Publication
(10) Pub. No.: US 2026/0121151 A1
(43) Pub. Date: Apr. 30, 2026

(54) Method to extend the total cumulative lifespan of a battery by reducing ambient temperature

(71) Applicant: Yueqin Cui, Luoyang (CN)

(72) Inventors: Dongzhen Lyu, Luoyang (CN); Jiawei Xiang, Luoyang (CN); Huiling Chen, Luoyang (CN); Liyan Chen, Luoyang (CN); Binjun Yan, Luoyang (CN)

(21) Appl. No.: 19/433,834

(22) Filed: Dec. 28, 2025

Related U.S. Application Data
(63) Continuation of application No. PCT/CN2025/112854, filed on Aug. 5, 2025.

(30) Foreign Application Priority Data
Jul. 12, 2024 (CN) 2024109328814
Aug. 5, 2025 (WO) PCT/CN2025/112854

(51) Int. Cl. H01M 10/633; H01M 10/613; H01M 10/635

(52) U.S. Cl. CPC H01M 10/633; H01M 10/613; H01M 10/635

(57) ABSTRACT

This invention extends battery lifetime by reducing ambient temperature through these steps: adjusting ambient temperature, conducting degradation tests to obtain SOH degradation curves under various temperatures; analyzing the real-time and long-term effects of temperature drops on SOH loss and lifetime gain; balancing negative SOH impacts and positive lifetime gains to calculate the optimal ambient temperature; dynamically regulating ambient temperature to keep battery temperature within ±2° C. of optimal. Selecting this optimal temperature doubles the battery's total cumulative lifetime without seriously affecting single-charge performance, significantly reducing replacement and maintenance costs.

### CROSS REFERENCE TO RELATED APPLICATIONS

This application claims priority to International Application No. PCT/CN2025/112854, filed Aug. 5, 2025, which claims priority to Chinese Patent Application No. 2024109328814, filed Jul. 12, 2024, in China. The entire contents of the aforementioned applications are hereby incorporated by reference in their entirety.

### TECHNICAL FIELD

This invention relates to the field of battery technology, and in particular to a method for extending the total cumulative lifetime of a battery by reducing the ambient temperature.

### BACKGROUND OF THE INVENTION

With the development of new energy technologies and industries, batteries are widely used in various fields and industries, and their reliable operation is crucial for the normal use of equipment. However, it is generally accepted that low-temperature operating environments will adversely affect the performance of lithium batteries, so lithium batteries are often avoided in low-temperature environments.

### SUMMARY OF THE INVENTION

As is well known, lithium iron phosphate batteries have poor low-temperature performance. At low temperatures, battery activity decreases, lithium insertion and extraction capabilities decline, and usable battery capacity decreases. Taking a certain battery as an example, the capacity retention rate is 100% at an operating temperature of 25° C., approximately 80% at 0° C., and only about 55% at −20° C. Ambient temperature has a significant impact on the usable battery capacity. To ensure the normal operation of the equipment driven by the battery, the battery operating ambient temperature is generally maintained at around 20-25° C. In low-temperature environments, measures such as heat insulation of the battery compartment and the installation of heaters are generally taken to ensure the safe and efficient operation of energy storage equipment.

Generally speaking, the industry generally believes that low-temperature environments are unfavorable conditions for battery operation. For example, adding a battery preheating system to new energy electric vehicles ensures that the battery maintains a normal operating temperature, preventing significant capacity degradation and thus ensuring the normal operation of the electric vehicle. However, the inventors have found through experiments that this method is not conducive to extending the cumulative service life of the battery and also increases the frequency of battery replacement and maintenance costs.

In view of the above-mentioned shortcomings of the prior art, the purpose of the present invention is to provide a method for extending the total cumulative lifetime of a battery by reducing the ambient temperature, in order to solve the problem that the battery's cumulative life is not extended when it is operating at normal temperature, and that the frequency of battery replacement and maintenance costs are also increased.

To achieve the above and other related objectives, the present invention provides a method for extending the total cumulative lifetime of a battery by reducing ambient temperature, comprising:
Obtain the degradation curve: Adjust the ambient temperature, conduct a degradation test on the batteries, and obtain the degradation curve of the batteries'SOH index with cumulative usage under different ambient temperatures;
Obtain the temperature-drop-induced SOH loss: Analysis the real-time effect of ambient temperature on the SOH index, obtain the temperature-drop-induced SOH loss caused by different temperature drop amplitudes;
Obtain the temperature-drop-induced lifetime gain: Analysis the long-term influence of ambient temperature on the degradation curve, obtain the temperature-drop-induced lifetime gain caused by different temperature drop amplitudes;
Calculate the optimal ambient temperature: with obtained temperature-drop-induced SOH loss and temperature-drop-induced lifetime gain, balance the negative impact of the temperature drop amplitude on the SOH index and the positive impact of the temperature drop amplitude on the total cumulative lifetime, and calculate the optimal ambient temperature;
Adjust the battery's body temperature: Dynamically regulate the ambient temperature surrounding the battery, ensuring that the battery's body temperature remains within ±2° C. of the optimal ambient temperature.

Optionally, when balancing the negative impact of the temperature drop amplitude on the SOH index and the positive impact of the temperature drop amplitude on the total cumulative lifetime, a weighting coefficient A is set and multiplied by the temperature-drop-induced SOH loss, and a weighting coefficient B is set and multiplied by the temperature-drop-induced lifetime gain, and then the two product results are added together to obtain a comprehensive balance index; adjusting the ambient temperature of the battery can change the temperature drop amplitude, thereby affecting the value of the comprehensive balance index, and when the value of the comprehensive balance index is the maximum value, the ambient temperature is the optimal ambient temperature; wherein, the weighting coefficient A and weighting coefficient B are preset or obtained after training a mathematical model, and their values can be positive or negative.

Optionally, the total cumulative lifetime is calculated as the cumulative usage from the time the battery is put into use until the SOH index reaches the failure threshold; the failure threshold is a certain value in the possible value range of the SOH index of the battery, and when the SOH index reaches the failure threshold, the battery cannot continue to work stably.

Optionally, the SOH index includes one or more of the following: actual maximum energy storage capacity, actual maximum energy storage capacity attenuation, actual maximum power storage capacity, actual maximum power storage capacity attenuation, relative energy storage capacity, relative energy storage capacity attenuation, relative power storage capacity attenuation, actual internal resistance, actual internal resistance attenuation, single actual discharge duration, single actual discharge duration attenuation, relative discharge duration, single actual charging duration, single actual charging duration attenuation, relative charging duration, actual work done by the battery's actual maximum energy storage capacity for the operation of power-consuming equipment, and mileage generated by the battery's actual maximum energy storage capacity for vehicle driving.

Optionally, the cumulative usage is the cumulative result of the actual usage measurement of the battery, and the method for calculating the value of the cumulative usage at a specific time is the cumulative result of the actual usage measurement generated within the time range from when the battery is put into use to before the specific time.

Optionally, the types of cumulative usage include one or more of the following: cumulative charging amount, cumulative discharging amount, cumulative absolute value charge/discharge amount, cumulative charging duration, cumulative discharging duration, cumulative charge/discharge duration, cumulative idle time, cumulative charging times, cumulative discharging times, cumulative charge/discharge times, cumulative idle times, calendar service time, cumulative result of actual workload generated by the battery supplying power to power-consuming equipment, cumulative result of actual work done by the battery supplying power to power-consuming equipment, and cumulative result of actual mileage generated by the battery supplying power to the vehicle.

Optionally, the method for calculating the temperature-drop-induced SOH loss is as follows: for a battery under a specific cumulative usage, the SOH index value corresponding to the battery body temperature at a certain temperature T1 is represented by R1, and the SOH index value corresponding to the battery body temperature at another temperature T2 is represented by R2, then the difference between R1 and R2 is the temperature-drop-induced SOH loss, wherein the value of T2 is lower than the value of T1.

Optionally, the method for calculating the temperature-drop-induced lifetime gain is as follows: for a battery under a specific cumulative usage, the total cumulative lifetime expected to operate when the battery body temperature is at a certain temperature T1 is represented by L1, and the total cumulative lifetime expected to operate when the battery body temperature is at a certain temperature T2 is represented by L2, then the difference between L1 and L2 is the temperature-drop-induced lifetime gain.

Optionally, the possible value of the ambient temperature is within a ±0.5° C. range of at least one integer temperature between −50° C. and 50° C.; the possible values of T1, T2 and the optimal ambient temperature are each within a ±0.5° C. range of at least one integer temperature between −50° C. and 50° C.; and the upper and lower limits of the possible value range for T1, T2 and the optimal ambient temperature align with the upper and lower limits of the possible value range for the ambient temperature.

Optionally, the upper limit of the possible value range of ambient temperature includes one of the following: 50° C., 45° C., 40° C., 35° C., 30° C., 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., and −15° C.; the lower limit of the possible value range of ambient temperature includes one of the following: 30° C., 25° C., 22.5° C., 20° C., 17.5° C., 15° C., 12.5° C., 10° C., 7.5° C., 5° C., 2.5° C., 0° C., −2.5° C., 5° C., −7.5° C., −10° C., −12.5° C., −15° C., −17.5° C., −20° C., −22.5° C., −25° C., −27.5° C., −30° C., −32.5° C., −35° C., −37.5° C., −40° C., −42.5° C., −45° C., −47.5° C., −50° C.

In the aforementioned method of extending the total cumulative lifetime of a battery by reducing ambient temperature, the inventors, through extensive experimental research, discovered that the cumulative usage of the battery can accurately describe the performance degradation process of lithium batteries under random and complex scenarios. The total cumulative lifetime can highly homogenize the significantly different performance degradation processes of lithium batteries under various complex and random scenarios. Simultaneously, the inventors also found that although placing the lithium module in a low-temperature environment leads to a sharp decrease in lithium battery capacity, the low-temperature environment does not cause permanent damage to the lithium battery capacity. On the contrary, the low-temperature environment can significantly extend the total cumulative lifetime of the lithium battery, including cumulative charging capacity and cumulative discharging capacity. Furthermore, the capacity of the lithium battery recovers rapidly when the ambient temperature returns to room temperature. This indicates that a low-temperature environment can be considered a beneficial factor; actively creating a low-temperature environment helps extend the total cumulative lifetime of lithium batteries, and is particularly suitable for energy storage scenarios where the requirements for lithium battery capacity are not high, but the requirements for cumulative charging capacity are high.

In summary, although low temperatures negatively impact battery capacity, this effect is not permanent. On the contrary, low temperatures significantly extend the battery's total cumulative lifetime; that is, by adjusting the ambient temperature, battery life can be increased. Specifically, by balancing the negative impact of temperature drop amplitude on the SOH index with its positive impact on the battery's total cumulative lifetime, an optimal ambient temperature can be selected for the battery. At this optimal ambient temperature, the basic single-charge range performance is not severely affected, while the battery's total cumulative lifetime is doubled, thereby significantly reducing battery replacement and maintenance costs.

### BRIEF DESCRIPTION OF DRAWINGS

FIG. 1 is a flowchart of the steps of a method for extending the total cumulative lifetime of a battery by reducing the ambient temperature in an embodiment of the present invention;

FIG. 2 shows the degradation curves of the SOH index of a single battery with cumulative usage at the reference operating temperature and in a low-temperature environment;

FIG. 3 is a scatter plot of the battery SOH index as a function of cumulative usage under temperature disturbance at the baseline operating temperature within a certain cumulative usage range;

FIG. 4 shows the degradation curves of the SOH index of the battery with cumulative usage for two batteries connected in series and a single battery under the reference operating temperature and low temperature environment.

### DETAILED DESCRIPTION OF THE INVENTION

The following specific examples illustrate the embodiments of the present invention. Those skilled in the art can easily understand other advantages and effects of the present invention from the content disclosed in this specification. The present invention can also be implemented or applied through other different specific embodiments, and various details in this specification can also be modified or changed based on different viewpoints and applications without departing from the spirit of the present invention.

The embodiments of the present invention will be described below with reference to the accompanying drawings and preferred embodiments. Those skilled in the art can easily understand other advantages and effects of the present invention from the content disclosed in this specification. The present invention can also be implemented or applied through other different specific embodiments, and various details in this specification can also be modified or changed based on different viewpoints and applications without departing from the spirit of the present invention. It should be understood that the preferred embodiments are only for illustrating the present invention and are not intended to limit the scope of protection of the present invention.

It should be noted that the illustrations provided in the following embodiments are only schematic representations of the basic concept of the present invention. Therefore, the drawings only show the components related to the present invention and are not drawn according to the actual number, shape and size of the components. In actual implementation, the form, quantity and proportion of each component can be arbitrarily changed, and the layout of the components may also be more complex.

In the following description, numerous details are explored to provide a more thorough explanation of embodiments of the invention; however, it will be apparent to those skilled in the art that embodiments of the invention may be practiced without these specific details, and in other embodiments, well-known structures and devices are shown in block diagram form rather than in detail to avoid obscuring embodiments of the invention.

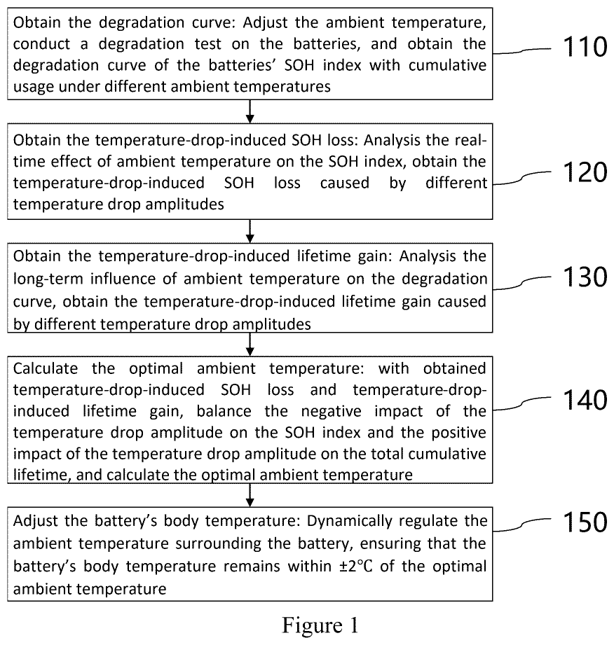

In an exemplary embodiment, as shown in FIG. 1, a method for extending the total cumulative lifetime of a battery by reducing the ambient temperature includes at least steps S110 to S150, which are described in detail below:
Step S110: Obtain the degradation curve: Adjust the ambient temperature, conduct a degradation test on the batteries, and obtain the degradation curve of the batteries' SOH index with cumulative usage under different ambient temperatures;

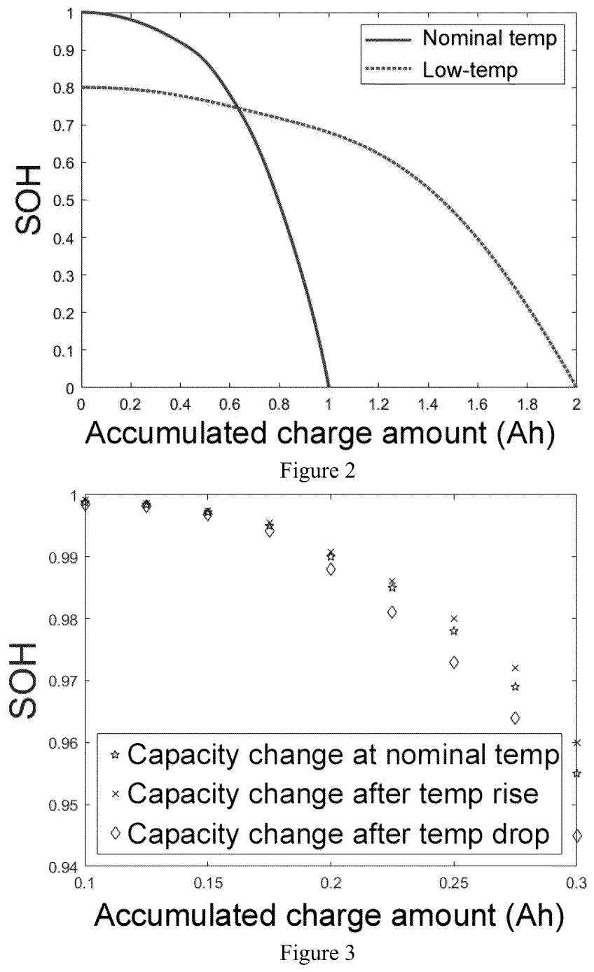

As shown in FIG. 2, the total cumulative lifetime of the battery at the reference operating temperature is much shorter than that of the battery at low temperature, and the SOH index of the battery at low temperature is lower than that at the reference operating temperature, which is consistent with existing common knowledge.

Among them, the degradation curve is used to describe the relationship between the SOH index and the cumulative usage during battery use. As the value of the cumulative usage increases, the value of the SOH index will gradually decrease.

In some embodiments, the upper limit of the possible value range of ambient temperature includes one of the following: 50° C., 45° C., 40° C., 35° C., 30° C., 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., and −15° C.; the lower limit of the possible value range of ambient temperature includes one of the following: 30° C., 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C., −17.5° C., −20° C., −22.5° C., −25° C., −27.5° C., −30° C., −32.5° C., −35° C., −37.5° C., −40° C., −42.5° C., −45° C., −47.5° C., −50° C. Specifically, the possible value of the optimal ambient temperature is within a ±0.5° C. range of at least one integer temperature between −50° C. and 50° C., including but not limited to this range.

It should be noted that the inventor's purpose in adjusting the battery ambient temperature is to extend the total cumulative lifetime of the lithium battery, but this does not limit the application of this solution in charge/discharge cycle scenarios. Because the number of charge/discharge cycles is only a superficial indicator, adjusting the battery ambient temperature may not necessarily extend the charge/discharge cycle lifespan, but the number of charge/discharge cycle lifespans does not affect the total cumulative lifetime of the lithium battery. This solution can substantially extend the total cumulative lifetime of the lithium battery, and this effect is not changed by whether or not cycle count is used to describe the battery performance degradation process.

In some embodiments, the SOH index includes one or more of the following: actual maximum energy storage capacity, actual maximum energy storage capacity attenuation, actual maximum power storage capacity, actual maximum power storage capacity attenuation, relative energy storage capacity, relative energy storage capacity attenuation, relative power storage capacity attenuation, actual internal resistance, actual internal resistance attenuation, single actual discharge duration, single actual discharge duration attenuation, relative discharge duration, single actual charging duration, single actual charging duration attenuation, relative charging duration, actual work done by the battery's actual maximum energy storage capacity for the operation of power-consuming equipment, and mileage generated by the battery's actual maximum energy storage capacity for vehicle driving.

It should be noted that SOH (State of Health) is an important indicator for measuring the degree of battery performance degradation, and is usually used to describe the current health and performance of the battery. SOH is expressed as a percentage, where 100% SOH means that the battery performance is exactly the same as when it left the factory. The formula for calculating SOH is: Current Performance/Initial Performance×100%. Current performance refers to the battery's capability in its current state, which may involve factors such as battery capacity and output power; initial performance refers to the battery's original performance state when it left the factory. Over time and with increased battery use, the battery's capacity and performance will usually gradually decline. This decline is reflected in the gradual decrease of SOH. For example, if a battery's current capacity is only 80% of its initial capacity, then its SOH is 80%. In this solution, the SOH index includes information on changes in battery performance characteristics, used to measure the degree of battery performance loss or health status.

In some embodiments, the cumulative usage is the cumulative result of the actual usage measurement of the battery, and the method for calculating the value of the cumulative usage at a specific time is the cumulative result of the actual usage measurement generated within the time range from when the battery is put into use to before the specific time.

The cumulative usage of the battery will increase continuously with daily use. The cumulative usage is closely related to the choice of measurement time; the calculated cumulative usage may differ at different measurement times. The specific time mentioned here is intended to illustrate the correspondence between the two. The emphasis on “specific time” here is not to limit the value of that time, but merely to illustrate that the cumulative usage is related to a specific time. When calculating the cumulative usage, the corresponding measurement time must be clearly defined.

In some implementations, the types of cumulative usage include one or more of the following: cumulative charging amount, cumulative discharging amount, cumulative absolute value charge/discharge amount, cumulative charging duration, cumulative discharging duration, cumulative charge/discharge duration, cumulative idle time, cumulative charging times, cumulative discharging times, cumulative charge/discharge times, cumulative idle times, calendar service time, cumulative result of actual workload generated by the battery supplying power to power-consuming equipment, cumulative result of actual work done by the battery supplying power to power-consuming equipment, and cumulative result of actual mileage generated by the battery supplying power to the vehicle.

Specifically, cumulative charge amount refers to the total amount of electricity charged into the battery during its entire use, usually measured in Ah; cumulative discharge amount refers to the total amount of electricity discharged into the battery during its entire use, usually measured in Ah; cumulative absolute charge/discharge amount refers to the total absolute charge/discharge amount accumulated by the battery during its entire use, usually measured in Ah; cumulative charging time refers to the total charging time accumulated by the battery during its entire use, usually measured in hours; cumulative discharging time refers to the total discharging time accumulated by the battery during its entire use, usually measured in hours; and cumulative charge/discharge time refers to the total charge/discharge time accumulated by the battery during its entire use, usually measured in hours. The terms are measured in hours, cumulative idle time (in hours) , cumulative charge count (in hours), cumulative discharge count (in hours), cumulative charge/discharge count (in hours), cumulative charge/discharge count (in hours), cumulative idle time (in hours), and cumulative calendar service time (in days).

Here, we take cumulative discharge as an example to illustrate the practical significance of cumulative usage. Cumulative discharge represents the amount of electricity discharged by the battery from the time it is put into use until a certain point in its operation. For a battery, from the moment it is put into use, it will continuously be charged or discharged. The cumulative discharge is obtained by summing the amount of electricity discharged in each discharge process. Similarly, cumulative usage can also include cumulative charge, cumulative discharge, and cumulative absolute charge/discharge. Batteries with high cumulative charging time, cumulative discharging time, and cumulative charge/discharge time usually mean they are used more frequently, which significantly affects the battery's total cumulative lifetime; therefore, these three are included in cumulative usage. Similarly, cumulative usage can also include cumulative idle time, cumulative number of charges, cumulative number of discharges, cumulative number of charge/discharge cycles, and cumulative number of idle cycles.

In some embodiments, the total cumulative lifetime is calculated as the cumulative usage from the time the battery is put into use until the SOH index reaches the failure threshold; the failure threshold is a certain value in the possible value range of the SOH index of the battery, and when the SOH index reaches the failure threshold, the battery cannot continue to work stably.

The failure threshold can be a pre-set value, that is, a value within the possible value range of the battery's SOH index. For example, if the failure threshold is pre-set to 20% of the battery's rated capacity, then for a battery with a rated capacity of 1000 mAh, its failure threshold is 200 mAh. When the SOH index reaches 200 mAh, the cumulative usage corresponding to that point on the degradation curve is the total cumulative lifetime under that failure threshold.

Step S120: Obtain the temperature-drop-induced SOH loss: Analysis the real-time effect of ambient temperature on the SOH index, obtain the temperature-drop-induced SOH loss caused by different temperature drop amplitudes.

It should be noted that the temperature-drop-induced SOH loss includes the immediate loss of the SOH index value after the battery's body temperature changes. Here, “immediate effect” is used to describe the influence of ambient temperature on the SOH index, that is, the battery's SOH index is very sensitive to transient changes in ambient temperature. In other words, even a small, instantaneous change in ambient temperature will cause a significant change in the SOH index. As shown in FIG. 3, within a short observation period, disturbances in ambient temperature will cause the battery's SOH index to fluctuate around the baseline degradation curve.

The temperature-drop-induced SOH loss is also affected by operating conditions. When operating conditions change, the temperature-drop-induced SOH loss will also change accordingly. Therefore, the influence of operating conditions should be considered when calculating the temperature-drop-induced SOH loss. Specifically, operating conditions include various operating conditions during battery operation. In the actual operation of the battery, different operating condition settings will affect the battery performance, and simultaneously affect the dynamic changes in temperature-drop-induced SOH loss and temperature-drop-induced lifetime gain. The selectable types of operating conditions include: the specific changes or average values of the battery's output current, output voltage, and output power during battery operation; air humidity; heat dissipation conditions; air pressure conditions; equipment operating power; equipment production efficiency; vehicle speed, etc.

Specifically, output current is the magnitude of the current output through the positive and negative terminals of the rechargeable battery, and output power is the magnitude of the power output through the positive and negative terminals of the rechargeable battery. Generally speaking, the product of output voltage and output current is the output power. In practical battery applications, output current often changes. However, due to the internal resistance of the rechargeable battery, different current magnitudes result in different internal energy losses, which alter the internal cell temperature and thus affect the battery surface temperature, thereby changing the calculated temperature-drop-induced SOH loss. Simultaneously, in practical applications, battery performance inevitably degrades. This degradation manifests as a gradual increase in the battery's internal resistance, leading to increased internal energy losses. The increased internal resistance causes the battery's output voltage to gradually decrease. As the output voltage decreases, the battery voltage is more likely to reach the failure threshold, causing premature battery failure, thus changing the calculated temperature-drop-induced lifetime gain.

During battery operation, air humidity and air pressure conditions affect the battery's electrochemical reaction rate, thus affecting battery performance; heat dissipation conditions affect the battery surface temperature, thus affecting the amount of temperature-drop-induced SOH loss and the temperature-drop-induced lifetime gain. Therefore, air humidity, heat dissipation conditions, and air pressure conditions are also included in the operating conditions. Equipment operating power is the actual operating power of the power-consuming equipment when the battery is supplying it for normal operation; equipment production efficiency is the amount of work that the power-consuming equipment can generate per unit time when the battery is supplying it for normal operation; vehicle speed is the distance that the vehicle can travel per unit time when the battery is supplying it for normal operation.

In some embodiments, the method for calculating the temperature-drop-induced SOH loss is as follows: for a battery under a specific cumulative usage, the SOH index value corresponding to the battery body temperature at a certain temperature T1 is represented by R1, and the SOH index value corresponding to the battery body temperature at another temperature T2 is represented by R2, then the difference between R1 and R2 is the temperature-drop-induced SOH loss, wherein the value of T2 is lower than the value of T1.

The upper and lower limits of the possible value range for T1 and T2 align with the upper and lower limits of the possible value range for the ambient temperature, that is, the possible values of T1 and T2 is within a ±0.5° C. range of at least one integer temperature between −50° C. and 50° C., including but not limited to this range. The magnitude of the temperature-drop-induced SOH loss will change with the specific cumulative usage, T1, and T2. The variation law of the temperature-drop-induced SOH loss with cumulative usage, T1, and T2 can be reflected by the temperature-induced performance loss model.

Among them, the temperature-induced performance loss model includes both relatively simple mathematical models and more complex neural network models. Common mathematical models include stochastic models, continuous-time models, discrete-time models, difference equation models, algebraic equation models, differential equation models, system of equations models, linear models, nonlinear models, regression models, Markov chain models, stochastic process models, etc.; common neural network models include support vector machines, deep learning networks, extreme learning networks, recurrent neural networks, generative adversarial networks, convolutional neural networks, long short-term memory networks, autoencoders, Boltzmann machines, deep belief networks, etc. When selecting a specific model type, it can be flexibly chosen according to the actual deployment and application scenario; the specific construction method is as follows: first, select a suitable neural network model structure, then train the selected neural network model structure based on the battery's historical data, and finally generate and construct a complete neural network model.

Specifically, mathematical models are established based on the understanding of the physical and chemical laws governing the battery charging and discharging process. Common mathematical models include: stochastic models, which consider random factors in the battery charging and discharging process, such as changes in ambient temperature and load current; continuous-time models, which treat the battery charging and discharging process as a continuous process and describe it using mathematical tools such as differential equations; discrete-time models, which treat the battery charging and discharging process as a discrete process and describe it using mathematical tools such as difference equations; difference equation models, which use difference equations to describe the changing patterns of state variables such as voltage, current, and energy storage capacity; algebraic equation models, which use algebraic equations to describe the static characteristics of the battery, such as open-circuit voltage and internal resistance; differential equation models, which use differential equations to describe the dynamic characteristics of the battery, such as the changing patterns of state variables such as voltage, current, and energy storage capacity; system of equations models, which use multiple equations to describe multiple state variables or characteristics of the battery; linear models, which assume a linear relationship between the battery's state variables and independent variables; and nonlinear models, which do not assume a linear relationship between the battery's state variables and independent variables. Regression models use statistical methods to establish the relationship between the battery's state variables and independent variables. Markov chain models treat the battery's states as discrete states and use Markov chains to describe the transition probabilities between states. Stochastic process models use stochastic processes to describe the changing patterns of the battery's state variables.

Neural network models are machine learning models inspired by biological nervous systems. They can learn complex nonlinear relationships from data and are used for various prediction tasks. Common neural network models include: Support Vector Machines (SVMs), a supervised learning algorithm used for classification and regression; Deep Learning Networks (DNNs), neural networks composed of multiple hidden layers, with powerful feature extraction and learning capabilities; Extreme Learning Networks (ELNs), a type of fast-learning neural network that can achieve good performance on relatively small datasets; Recurrent Neural Networks (RNNs), capable of handling sequential data, such as time series data; Generative Adversarial Networks (GANs), a model composed of two neural networks, one for generating data and the other for judging the authenticity of data; Convolutional Neural Networks (CNNs), adept at handling image data; Long Short-Term Memory (LSTM) networks, a type of recurrent neural network capable of handling long-range dependencies; Autoencoders (Autoencoders), a type of neural network used for dimensionality reduction and feature extraction; Boltzmann Machines (BLMs), a probability-based model capable of learning the distribution of data; and Deep Belief Networks (DBNs), a model composed of multiple autoencoders with hierarchical feature representation capabilities.

When selecting a specific model for the temperature-induced performance loss model, the following factors need to be considered: 1. Data availability: If sufficient historical data is available, data-driven models, such as neural network models, can be used; if the amount of data is limited, models based on physical laws, such as mathematical models, can be used. 2. Model complexity: Complex models often have higher accuracy but also require more computational resources; the appropriate model complexity needs to be selected based on the actual application scenario. 3. Model robustness: The model should be able to cope with rechargeable batteries under various operating conditions. 4. Model interpretability: If understanding the model's prediction results is required, a model with strong interpretability should be selected.

Step S130: Obtain the temperature-drop-induced lifetime gain: Analysis the long-term influence of ambient temperature on the degradation curve, obtain the temperature-drop-induced lifetime gain caused by different temperature drop amplitudes.

It should be noted that the term “long-term effect” is used here to describe the influence of ambient temperature on the degradation rate. This means that ambient temperature may fluctuate frequently and instantaneously, but the rate of change of the battery degradation curve is usually difficult to change significantly in a short period of time. In other words, the battery's total cumulative lifetime is usually difficult to change significantly in a short period of time. Therefore, to accurately assess the influence of ambient temperature on the cumulative battery life, continuous observation and analysis are required over a relatively long observation window. The term “long-term” here is intended to reveal the persistence and cumulative nature of this influence.

Among them, the temperature-drop-induced lifetime gain includes the increase in total cumulative lifetime caused by the slowdown of the degradation rate when the battery is running at a low body temperature for a long time. The temperature-drop-induced lifetime gain is also affected by the operating conditions. When the operating conditions change, the temperature-drop-induced lifetime gain will also change accordingly. When calculating the temperature-drop-induced lifetime gain, the influence of the operating conditions should also be considered, just like in step S120.

In some embodiments, the method for calculating the temperature-drop-induced lifetime gain is as follows: for a battery under a specific cumulative usage, the total cumulative lifetime expected to operate when the battery body temperature is at a certain temperature T1 is represented by L1, and the total cumulative lifetime expected to operate when the battery body temperature is at a certain temperature T2 is represented by L2, then the difference between L1 and L2 is the temperature-drop-induced lifetime gain, where the value of T2 is lower than the value of T1. The magnitude of the temperature-drop-induced lifetime gain changes with the specific cumulative usage, T1, and T2; the variation law of the temperature-drop-induced lifetime gain with cumulative usage, T1, and T2 can be summarized by constructing a temperature-induced lifetime gain model.

This section clarifies the meaning of “specific cumulative usage”: The values of temperature-drop-induced SOH loss and temperature-drop-induced lifetime gain are related to the current ambient temperature, the temperature drop amplitude, and the optimal ambient temperature, and are also closely related to the battery's current cumulative usage. The emphasis here on “specific cumulative usage” does not limit the value of the cumulative usage; it merely illustrates that the values of temperature-drop-induced SOH loss and temperature-drop-induced lifetime gain are related to changes in cumulative usage. When calculating the optimal ambient temperature and temperature drop amplitude, the value of the cumulative usage needs to be clearly defined first. Simply put, when calculating the temperature-drop-induced lifetime gain and temperature-drop-induced SOH loss, the battery's cumulative usage needs to be obtained beforehand, and then, based on the constructed mathematical model or a trained AI model, the corresponding temperature-drop-induced lifetime gain and temperature-drop-induced SOH loss can be obtained.

Temperature-induced lifetime gain models include both relatively simple mathematical models and more complex neural network models. Common mathematical models include stochastic models, continuous-time models, discrete-time models, difference equation models, algebraic equation models, differential equation models, systems of equations models, linear models, nonlinear models, regression models, Markov chain models, stochastic process models, etc.; common neural network models include support vector machines, deep learning networks, extreme learning networks, recurrent neural networks, generative adversarial networks, convolutional neural networks, long short-term memory networks, autoencoders, Boltzmann machines, deep belief networks, etc. The specific model type can be flexibly selected based on the actual deployment and application scenario. The specific construction method is as follows: first, select a suitable neural network model structure; then, train the selected neural network model structure based on the battery's historical data; finally, generate and construct a complete neural network model. The selection of specific model types for temperature-induced lifetime gain models can refer to the approach for temperature-induced performance loss models.

Step S140: Calculate the optimal ambient temperature: with obtained temperature-drop-induced SOH loss and temperature-drop-induced lifetime gain, balance the negative impact of the temperature drop amplitude on the SOH index and the positive impact of the temperature drop amplitude on the total cumulative lifetime, and calculate the optimal ambient temperature.

Among them, the temperature-drop-induced SOH loss represents the degree of loss of battery capacity due to the temperature drop amplitude, and the temperature-drop-induced lifetime gain represents the degree of improvement of the battery's total cumulative lifetime due to the temperature drop amplitude. By reasonably selecting the temperature drop amplitude, these two values can be determined to double the battery's total cumulative lifetime without seriously affecting the single-charge range performance.

In some embodiments, when balancing the negative impact of the temperature drop amplitude on the SOH index and the positive impact of the temperature drop amplitude on the total cumulative lifetime, a weighting coefficient A is set and multiplied by the temperature-drop-induced SOH loss, and a weighting coefficient B is set and multiplied by the temperature-drop-induced lifetime gain, and then the two product results are added together to obtain a comprehensive balance index; adjusting the ambient temperature of the battery can change the temperature drop amplitude, thereby affecting the value of the comprehensive balance index, and when the value of the comprehensive balance index is the maximum value, the ambient temperature is the optimal ambient temperature; wherein, the weighting coefficient A and weighting coefficient B are preset or obtained after training a mathematical model, and their values can be positive or negative. This allows for a comprehensive consideration of the negative impact of the temperature drop amplitude on the SOH index and the positive impact of the temperature drop amplitude on the total cumulative lifetime.

Specifically, adjusting the ambient temperature of the battery can change the cooling rate, thereby affecting the value of the comprehensive balance index. When the value of the comprehensive balance index is at its maximum, the ambient temperature is the optimal ambient temperature. Maintaining the ambient temperature as the optimal ambient temperature can achieve dual optimization of temperature-drop-induced lifetime gain and temperature-drop-induced SOH loss.

In some embodiments, the upper and lower limits of the possible value range for the optimal ambient temperature align with the upper and lower limits of the possible value range for the ambient temperature, that is, the possible value of the optimal ambient temperature is within a ±0.5° C. range of at least one integer temperature between −50° C. and 50° C.

Step S150: Adjust the battery's body temperature: Dynamically regulate the ambient temperature surrounding the battery, ensuring that the battery's body temperature remains within ±2° C. of the optimal ambient temperature.

The types of batteries mentioned in this plan include: lithium batteries, lithium-ion batteries, lithium-sulfur batteries, sodium batteries, sodium-ion batteries, aluminum batteries, aluminum-ion batteries, air batteries, graphene batteries, sulfur batteries, nickel-metal hydride batteries, lead-acid batteries, all-solid-state batteries, solid-liquid hybrid batteries, metal batteries, metal-ion batteries, cylindrical batteries, polymer batteries, power batteries, halide batteries, silicon-based batteries, supercapacitors, fuel cells, or other energy storage devices that can be discharged; different battery models can be used when setting a series of ambient temperatures for long-term degradation testing of the batteries.

In this solution, to accurately extend the battery's total cumulative lifetime by reducing the ambient temperature, it is necessary to obtain the battery's body temperature, heat dissipation conditions, temperature-drop-induced SOH loss, temperature-drop-induced lifetime gain, and dynamically adjust the battery's ambient temperature. During battery operation, the ambient temperature is constantly changing due to heat exchange between the battery surface and the environment, and the battery's heat dissipation conditions. Therefore, obtaining the battery's body temperature and heat dissipation conditions, combined with the temperature-drop-induced SOH loss, temperature-drop-induced lifetime gain, and dynamically adjusting the battery's ambient temperature, ensures that the battery operates at the optimal ambient temperature in real time, thereby extending the battery's total cumulative lifetime.

In this solution, in order to further extend the total cumulative lifetime of the battery, an auxiliary battery can be equipped to add extra margin to the overall SOH index, making up for the negative impact of reduced ambient temperature. Equipping an auxiliary battery can also further increase the total cumulative lifetime. Furthermore, based on a comprehensive consideration of economic efficiency and to fully meet actual usage needs, the optimal capacity, number of batteries, and ambient temperature are determined to maximize overall benefits.

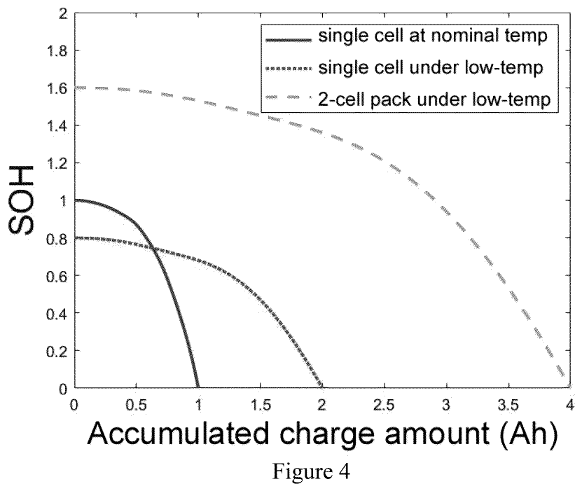

In the specific experiments conducted according to the above steps, as shown in FIG. 4, a multi-cell series compensation method was used to compensate for the temperature-drop-induced SOH loss in this low-temperature life extension method. Multiple degradation curves were obtained by conducting random incomplete charge-discharge tests on multiple batteries of the same model. The SOH index and total cumulative lifetime of two batteries under low-temperature conditions were twice that of a single battery under low-temperature conditions; the total cumulative lifetime of two batteries under low-temperature conditions was four times that of a single battery under low-temperature conditions. As can be seen from FIG. 4, setting a low-temperature environment nearly doubles the total cumulative lifetime, and connecting double the number of batteries in series also nearly doubles the total cumulative lifetime. In other words, setting a low-temperature environment and connecting batteries in series can increase the total cumulative lifetime by nearly four times.

This indicates that although the SOH index of a single battery will decrease in a low-temperature environment, for example, as shown in FIG. 4, by reducing it by 20%, the SOH index of two batteries of the same type connected in series in a low-temperature environment is higher than that of a single battery at the reference operating temperature, for example, as shown in FIG. 4, it is twice as high. This makes up for the temperature-drop-induced SOH loss in a low-temperature environment and achieves a balance between low-temperature life extension and battery capacity decay.

It should be noted that the figures of one time, four times, 20%, etc. mentioned above are merely illustrative and are only used to help understand the method and core ideas proposed in this invention, and are by no means intended to limit this disclosure or its application or use.

The above embodiments are merely illustrative of the principles and effects of the present invention and are not intended to limit the present invention. Any person skilled in the art can modify or alter the above embodiments without departing from the spirit and scope of the present invention. Therefore, all equivalent modifications or alterations made by those skilled in the art without departing from the spirit and technical concept disclosed in the present invention should still be covered by the claims of the present invention.

Generally, it is widely believed in the industry that low-temperature environments are unfavorable conditions for battery operation. The technical solution provided in this embodiment of the invention doubles the total cumulative lifetime of the battery without seriously affecting the single-charge range performance, significantly reducing the frequency of battery replacement and maintenance costs. This solution provides a method to extend the total cumulative lifetime of the battery by lowering the ambient temperature, which can double the total cumulative lifetime of the battery without seriously affecting the single-charge range performance, and has extremely high application prospects and economic value.

In summary, although low temperatures negatively impact battery capacity, this effect is not permanent. On the contrary, low temperatures significantly extend the battery's total cumulative lifetime. That is, by adjusting the ambient temperature, battery lifespan can be increased by two to three times.

1. A method for extending the total cumulative lifetime of a battery by reducing ambient temperature, characterized by comprising the following steps:
Obtain the degradation curve: Adjust the ambient temperature, conduct a degradation test on the batteries, and obtain the degradation curve of the batteries' SOH index with cumulative usage under different ambient temperatures;
Obtain the temperature-drop-induced SOH loss: Analysis the real-time effect of ambient temperature on the SOH index, obtain the temperature-drop-induced SOH loss caused by different temperature drop amplitudes;
Obtain the temperature-drop-induced lifetime gain: Analysis the long-term influence of ambient temperature on the degradation curve, obtain the temperature-drop-induced lifetime gain caused by different temperature drop amplitudes;
Calculate the optimal ambient temperature: with obtained temperature-drop-induced SOH loss and temperature-drop-induced lifetime gain, balance the negative impact of the temperature drop amplitude on the SOH index and the positive impact of the temperature drop amplitude on the total cumulative lifetime, and calculate the optimal ambient temperature;
Adjust the battery's body temperature: Dynamically regulate the ambient temperature surrounding the battery, ensuring that the battery's body temperature remains within ±2° C. of the optimal ambient temperature.

2. A method for extending the total cumulative lifetime of a battery by reducing the ambient temperature according to claim 1, characterized in that: when balancing the negative impact of the temperature drop amplitude on the SOH index and the positive impact of the temperature drop amplitude on the total cumulative lifetime, a weighting coefficient A is set and multiplied by the temperature-drop-induced SOH loss, and a weighting coefficient B is set and multiplied by the temperature-drop-induced lifetime gain, and then the two product results are added together to obtain a comprehensive balance index; adjusting the ambient temperature of the battery can change the temperature drop amplitude, thereby affecting the value of the comprehensive balance index, and when the value of the comprehensive balance index is the maximum value, the ambient temperature is the optimal ambient temperature; wherein, the weighting coefficient A and weighting coefficient B are preset or obtained after training a mathematical model, and their values can be positive or negative.

3. A method for extending the total cumulative lifetime of a battery by reducing the ambient temperature according to claim 2, characterized in that: the total cumulative lifetime is calculated as the cumulative usage from the time the battery is put into use until the SOH index reaches the failure threshold; the failure threshold is a certain value in the possible value range of the SOH index of the battery, and when the SOH index reaches the failure threshold, the battery cannot continue to work stably.

4. A method for extending the total cumulative lifetime of a battery by reducing ambient temperature according to claim 1, characterized in that: the SOH index includes one or more of the following: actual maximum energy storage capacity, actual maximum energy storage capacity attenuation, actual maximum power storage capacity, actual maximum power storage capacity attenuation, relative energy storage capacity, relative energy storage capacity attenuation, relative power storage capacity attenuation, actual internal resistance, actual internal resistance attenuation, single actual discharge duration, single actual discharge duration attenuation, relative discharge duration, single actual charging duration, single actual charging duration attenuation, relative charging duration, actual work done by the battery's actual maximum energy storage capacity for the operation of power-consuming equipment, and mileage generated by the battery's actual maximum energy storage capacity for vehicle driving.

5. A method for extending the total cumulative lifetime of a battery by reducing ambient temperature according to claim 1, characterized in that: the cumulative usage is the cumulative result of the actual usage measurement of the battery, and the method for calculating the value of the cumulative usage at a specific time is the cumulative result of the actual usage measurement generated within the time range from when the battery is put into use to before the specific time.

6. A method for extending the total cumulative lifetime of a battery by reducing ambient temperature according to claim 5, characterized in that: the types of cumulative usage include one or more of the following: cumulative charging amount, cumulative discharging amount, cumulative absolute value charge/discharge amount, cumulative charging duration, cumulative discharging duration, cumulative charge/discharge duration, cumulative idle time, cumulative charging times, cumulative discharging times, cumulative charge/discharge times, cumulative idle times, calendar service time, cumulative result of actual workload generated by the battery supplying power to power-consuming equipment, cumulative result of actual work done by the battery supplying power to power-consuming equipment, and cumulative result of actual mileage generated by the battery supplying power to the vehicle.

7. A method for extending the total cumulative lifetime of a battery by reducing ambient temperature according to claim 1, characterized in that: the method for calculating the temperature-drop-induced SOH loss is as follows: for a battery under a specific cumulative usage, the SOH index value corresponding to the battery body temperature at a certain temperature T1 is represented by R1, and the SOH index value corresponding to the battery body temperature at another temperature T2 is represented by R2, then the difference between R1 and R2 is the temperature-drop-induced SOH loss, wherein the value of T2 is lower than the value of T1.

8. A method for extending the total cumulative lifetime of a battery by reducing the ambient temperature according to claim 7, characterized in that: the method for calculating the temperature-drop-induced lifetime gain is as follows: for a battery under a specific cumulative usage, the total cumulative lifetime expected to operate when the battery body temperature is at a certain temperature T1 is represented by L1, and the total cumulative lifetime expected to operate when the battery body temperature is at a certain temperature T2 is represented by L2, then the difference between L1 and L2 is the temperature-drop-induced lifetime gain.

9. A method for extending the total cumulative lifetime of a battery by reducing the ambient temperature according to claim 8, characterized in that: the possible value of the ambient temperature is within a ±0.5° C. range of at least one integer temperature between −50° C. and 50° C.; the possible values of T1, T2 and the optimal ambient temperature are each within a ±0.5° C. range of at least one integer temperature between −50° C. and 50° C.; and the upper and lower limits of the possible value range for T1, T2 and the optimal ambient temperature align with the upper and lower limits of the possible value range for the ambient temperature.

10. A method for extending the total cumulative lifetime of a battery by reducing the ambient temperature according to any one of claims 1-9, characterized in that: the upper limit of the possible value range of ambient temperature includes one of the following: 50° C., 45° C., 40° C., 35° C., 30° C., 25° C., 22.5° C., 20° C., 17.5° C., 15° C., 12.5° C., 10° C., 7.5° C., 5° C., 2.5° C., 0 ° C., −2.5° C., −5° C., −7.5° C., −10° C., −12.5° C., and −15° C.; the lower limit of the possible value range of ambient temperature includes one of the following: 30° C., 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C., −17.5° C., −20° C., −22.5° C., −25° C., −27.5° C., −30° C., −32.5° C., −35° C., −37.5° C., −40° C., −42.5° C., −45° C., −47.5° C., −50° C.
